(19) United States
(12) Patent Application Publication
(10) Pub. No.: US 2026/0169809 A1
(43) Pub. Date: Jun. 18, 2026

(54) Method of Managing Vehicle Controller Having Plurality of Processing Units and Vehicle

(71) Applicants: Hyundai Motor Company, Seoul (KR); Kia Corporation, Seoul (KR)

(72) Inventors: Wang Seok Lee, Hwaseong-si (KR); Woo Tae Jeon, Hwaseong-si (KR); Woo Kyung Jung, Hwaseong-si (KR); Tae Ho Han, Hwaseoang-si (KR)

(21) Appl. No.: 19/400,938

(22) Filed: Nov. 25, 2025

(30) Foreign Application Priority Data
Dec. 13, 2024 (KR) 10-2024-0186097

(51) Int. Cl. G06F 9/50

(52) U.S. Cl. CPC G06F 9/5027

(57) ABSTRACT

Disclosed herein are a vehicle control circuit having plurality of processors and a method of managing such a vehicle control circuit. The method may include: receiving, by a root processor in a vehicle control circuit of a vehicle, management information of a plurality of leaf processors, in the vehicle control circuit, configured to execute an application for vehicle control of the vehicle; identifying, by the root processor and based on the management information, an operating mode of the vehicle control circuit; selecting, based on the operating mode and the management information, a first leaf processor for executing the application; and causing, by the root processor and based on a local memory of the first leaf processor being unavailable, the first leaf processor to: read component data, of the application, from a shared memory; and execute the application.

### CROSS-REFERENCE TO RELATED APPLICATION

This application claims priority to and the benefit of Korean Patent Application No. 10-2024-0186097, filed in the Korean Intellectual Property Office on Dec. 13, 2024, the disclosure of which is incorporated herein by reference in its entirety.

### TECHNICAL FIELD

The present disclosure relates to management of a vehicle controller, and in particular, to management of a vehicle controller having a plurality of processing units.

### BACKGROUND

Vehicles may be equipped with various features and functionalities for driving convenience. For example, autonomous driving features or manual driving assistance features may be supported in vehicles. In order to provide these features, software defined vehicles (SDVs) have been developed.

The vehicle software architecture following the transition to the SDV aims for simplification and high performance as the number of required functions increases. To this end, a vehicle controller may have a structure in which a plurality of high-performance application processing units, such as systems on chip (SoCs), are installed within a single controller. Each of the plurality of SoCs may have its own unique characteristics, and the SoCs in the vehicle controller may be implemented for increased efficiency and stability from the perspectives of both hardware and software perspectives.

The matters described in this Background section are only for enhancement of understanding of the background of the disclosure, and should not be taken as acknowledgement that they correspond to prior art already known to those skilled in the art.

### SUMMARY

The present disclosure is directed to providing a method of managing a vehicle controller for efficiently and stably managing a plurality of processing units built into the vehicle controller in terms of resources and operating states and a vehicle.

Technical problems to be solved in the present disclosure are not limited to the technical problems, which have been mentioned above, and other technical problems that are not mentioned will be clearly understood by those of ordinary skill in the art to which the present disclosure belongs from the following description.

According to one or more example embodiments of the present disclosure, a method may include: receiving, by a root processor in a vehicle control circuit of a vehicle, management information of a plurality of leaf processors, in the vehicle control circuit, configured to execute an application for vehicle control of the vehicle; identifying, by the root processor and based on the management information, an operating mode of the vehicle control circuit; selecting, by the root processor and based on the operating mode and the management information, a first leaf processor, of the plurality of leaf processors, for executing the application; and causing, by the root processor and based on a local memory of the first leaf processor being unavailable, the first leaf processor to: read component data, of the application, from a shared memory that is shared between the root processor and the plurality of leaf processors; and execute the application. The root processor may manage the plurality of leaf processors.

The method may further include causing, by the root processor and based on the local memory of the first leaf processor being available: the component data to be stored in the local memory of the first leaf processor; and the first leaf processor to read the component data from the local memory of the first leaf processor and execute the application.

Selecting the first leaf processor may include generating a load reduction request for the first leaf processor. The first leaf processor may be associated with the operating mode. The load reduction request may be based on the operating mode. The load reduction request for the first leaf processor may include at least one of: controlling the first leaf processor to execute another application on the first leaf processor; deactivating the first leaf processor by removing the component data from the local memory of the first leaf processor; or controlling the first leaf processor to reduce at least a portion of the component data stored in the local memory of the first leaf processor.

The management information may include: state information of the plurality of leaf processors, resource information of the plurality of leaf processors, and scheduling information of the plurality of leaf processors. The state information may include at least one of: application execution data of each of the plurality of leaf processors, operating state data indicating a power state or an activation state of each of the plurality of leaf processors, failure state data of each of the plurality of leaf processors, synchronization state data associated with an operation time of each of the plurality of leaf processors, or thermal state data of each of the plurality of leaf processors. The resource information may include at least one of: performance data related to a type of a component of each of the plurality of leaf processors and specifications of the component, or resource state data indicating a state of the component of each of the plurality of leaf processors according to execution of the application. The scheduling information includes at least one of: processing scheduling of the application, or scenario data of control processing of the vehicle control circuit for each leaf processor of the plurality of leaf processors.

Identifying the operating mode may include identifying a resource management mode by determining, based on the scheduling information or the resource state data, that the first leaf processor requires load reduction. Selecting the first leaf processor may include: selecting the first leaf processor further based on the resource information of each of the plurality of leaf processors; and controlling the first leaf processor to reduce load.

Selecting the first leaf processor may include: selecting, based on the resource management mode being identified according to the scheduling information, one or more leaf processor candidates, of the plurality of leaf processors, that have performance data capable of supporting execution of the application defined in the scheduling information; selecting the first leaf processor, of the one or more leaf processor candidates, that has resource state data indicating maximum resources; and controlling the first leaf processor to reduce load.

Selecting the first leaf processor may include: selecting, based on the resource management mode being identified according to the resource state data, another leaf processor, of the plurality of leaf processors, that has resource state data indicating maximum resources. The resource management mode may be identified based on the resource state data indicating that at least one state, of states of a plurality of components in the first leaf processor executing the application, indicates an unstable condition.

Identifying the operating mode may include detecting a redundancy mode by identifying, based on the failure state data, a failed leaf processor of the plurality of leaf processors. Selecting the first leaf processor may include selecting a leaf processor, of the plurality of leaf processors and other than the failed leaf processor, based on the failure state data and the resource information of each of the plurality of leaf processors. Selecting the first leaf processor may further include: selecting one or more leaf processor candidates, of the plurality of leaf processors, that have performance data indicating a predetermined similarity with the failed leaf processor in a normal state; and selecting the first leaf processor, of the one or more leaf processor candidates, that has resource state data indicating maximum resources.

The method may further include, prior to the selecting of the first leaf processor: determining, based on the failure state data of the root processor, whether the root processor fails; and replacing, based on a failure of the root processor, the root processor by determining one of the plurality of leaf processors in the normal state as a replacement root processor. Selecting the first leaf processor and the causing the first leaf processor to execute the application may be performed by the replacement root processor.

Identifying the operating mode may include detecting a thermal management mode by identifying, based on the thermal state data, a heat-generating leaf processor. Selecting the first leaf processor may include selecting, based on the thermal state data and the resource information of each of the plurality of leaf processors, a leaf processor other than the heat-generating leaf processor. Selecting the first leaf processor may further include: selecting one or more leaf processor candidates, from among one or more leaf processors having a reference thermal state or lower, having performance data having a predetermined similarity to the heat-generating leaf processor; and selecting the first leaf processor, of the one or more leaf processor candidates, that has resource state data indicating maximum resources.

According to one or more example embodiments of the present disclosure, a vehicle may include: a plurality of leaf processors configured to execute an application for vehicle control of the vehicle; a root processor configured to manage the plurality of leaf processors; a memory including: a shared memory that is shared by the root processor and the plurality of leaf processors; and a local memory for each leaf processor of the plurality of leaf processors. The memory may store at least one instruction that is configured, when executed by the root processor, to cause a control circuit of the vehicle to: receive management information of the plurality of leaf processors; identify, based on the management information, an operating mode of the control circuit; select, based on the operating mode and the management information, a first leaf processor, of the plurality of leaf processors, for executing the application; and cause, based on the local memory of the first leaf processor being unavailable, the first leaf processor to: read component data, of the application, from the shared memory; and execute the application.

The at least one instruction may be configured, when executed by the root processor, to further cause the control circuit to cause, based on the local memory of the first leaf processor being available: the component data to be stored in the local memory of the first leaf processor; and the first leaf processor to read the component data from the local memory of the first leaf processor and execute the application.

The at least one instruction may be configured, when executed by the root processor, to cause the control circuit to select the first leaf processor by generating a load reduction request for the first leaf processor. The first leaf processor may be associated with the operating mode. The load reduction request for the first leaf processor may be based on the operating mode. The load reduction request may include at least one of: controlling the first leaf processor to execute another application on the first leaf processor; deactivating the first leaf processor by removing the component data from the local memory of the first leaf processor; or controlling the first leaf processor to reduce at least a portion of the component data stored in the local memory of the first leaf processor.

The management information may include: state information of the plurality of leaf processors, resource information of the plurality of leaf processors, and scheduling information of the plurality of leaf processors. The state information may include at least one of: application execution data of each of the plurality of leaf processors, operating state data indicating a power state or an activation state of each of the plurality of leaf processors, failure state data of each of the plurality of leaf processors, synchronization state data associated with an operation time of each of the plurality of leaf processors, or thermal state data of each of the plurality of leaf processors. The resource information may include at least one of: performance data related to specifications of a component of each of the plurality of leaf processors, or resource state data indicating a state of the component of each of the plurality of leaf processors according to execution of the application. The scheduling information may include at least one of: processing scheduling of the application, or scenario data of control processing of the control circuit for each leaf processor of the plurality of leaf processors.

The at least one instruction may be configured, when executed by the root processor, to cause the control circuit to identify the operating mode by identifying a resource management mode by determining, based on the scheduling information or the resource state data, that the first leaf processor requires load reduction. The at least one instruction may be configured, when executed by the root processor, to cause the control circuit to select the first leaf processor by: selecting the first leaf processor further based on the resource information of each of the plurality of leaf processors; and controlling the first leaf processor to reduce load.

The at least one instruction may be configured, when executed by the root processor, to cause the control circuit to select the first leaf processor by: selecting, based on the resource management mode being identified according to the scheduling information, one or more leaf processor candidates, of the plurality of leaf processors, that have performance data capable of supporting execution of the application defined in the scheduling information; selecting the first leaf processor, of the one or more leaf processor candidates, that has resource state data indicating maximum resources; and controlling the first leaf processor to reduce load.

The at least one instruction may be configured, when executed by the root processor, to cause the control circuit to select the first leaf processor by: selecting, based on the resource management mode being identified according to the resource state data, another leaf processor, of the plurality of leaf processors, that has resource state data indicating maximum resources. The resource management mode may be identified based on the resource state data indicating that at least one state, of states of a plurality of components in the first leaf processor executing the application, indicates an unstable condition.

The at least one instruction may be configured, when executed by the root processor, to cause the control circuit to identify the operating mode by: detecting a redundancy mode by identifying, based on the failure state data, a failed leaf processor of the plurality of leaf processors. The at least one instruction may be configured, when executed by the root processor, to cause the control circuit to select the first leaf processor by: selecting a leaf processor, of the plurality of leaf processors and other than the failed leaf processor, based on the failure state data and the resource information of each of the plurality of leaf processors. The at least one instruction may be configured, when executed by the root processor, to cause the control circuit to select the first leaf processor further by: selecting one or more leaf processor candidates, of the plurality of leaf processors, that have performance data indicating a predetermined similarity with the failed leaf processor in a normal state; and selecting the first leaf processor, of the one or more leaf processor candidates, that has resource state data indicating maximum resources.

The at least one instruction may be configured, when executed by the root processor, to further cause the control circuit to, prior to selecting the first leaf processor: determine, based on the failure state data of the root processor, whether the root processor fails; and replace, based on a failure of the root processor, the root processor by determining one of the plurality of leaf processors in the normal state as a replacement root processor. The at least one instruction may be configured, when executed by the replacement root processor, to cause the control circuit to select the first leaf processor and cause the first leaf processor to execute the application.

The at least one instruction may be configured, when executed by the root processor, to cause the control circuit to identify the operating mode by: detecting a thermal management mode by identifying, based on the thermal state data, a heat-generating leaf processor. The at least one instruction may be configured, when executed by the root processor, to cause the control circuit to select the first leaf processor by: selecting, based on the thermal state data and the resource information of each of the plurality of leaf processors, a leaf processor other than the heat-generating leaf processor. The at least one instruction may be configured, when executed by the root processor, to cause the control circuit to select the first leaf processor further by: selecting one or more leaf processor candidates, from among one or more leaf processors having a reference thermal state or lower, having performance data having a predetermined similarity to the heat-generating leaf processor; and selecting the first leaf processor, of the one or more leaf processor candidates, that has resource state data indicating maximum resources.

The features briefly summarized above for this disclosure are only aspects of the detailed description of the disclosure which follow, and they are not intended to limit the scope of the disclosure.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a view showing an example vehicle transmitting and receiving data by communicating with other devices;

FIG. 2 is a diagram showing modules constituting an example vehicle;

FIG. 3 is a diagram showing modules constituting an example processing unit;

FIG. 4 is a diagram schematically showing an example scheme for management of leaf units by a root unit;

FIG. 5 is a diagram showing modules constituting an example server;

FIG. 6 is a flowchart showing an example method of managing a vehicle controller having a plurality of processing units;

FIG. 7 is a flowchart showing an example process for the vehicle controller in a resource management mode;

FIG. 8 is a flowchart showing an example process for the vehicle controller in a redundancy mode;

FIG. 9 is a flowchart showing an example process for the vehicle controller in a thermal management mode; and

FIG. 10 is a flowchart showing an example process for the vehicle controller in an operational mode and a synchronization mode.

### DETAILED DESCRIPTION

Hereinafter, one or more example embodiments of the present disclosure will be described in detail with reference to the accompanying drawings so that those skilled in the art may easily implement the present disclosure. However, the present disclosure may be implemented in various different ways, and is not limited to the example embodiment(s) described therein.

In describing example embodiment(s) of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example embodiment could be termed a second element in another example embodiment, and, similarly, a second element in an example embodiment could be termed a first element in another example embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various example embodiment(s) do not necessarily mean essential elements, and some of them may be optional elements. Therefore, one or more example embodiments composed of a subset of elements described those example embodiment(s) also included in the scope of the present disclosure. In addition, any example embodiments including other elements in addition to the elements described in those embodiments may also be included in the scope of the present disclosure.

The advantages and features of the present disclosure and the way of attaining them will become apparent with reference to the example embodiment(s) described herein in detail in conjunction with the accompanying drawings. The present disclosure, however, may be embodied in many different forms and should not be constructed as being limited to the example embodiment(s) set forth herein. Rather, these embodiment(s) are provided to provide examples of the disclosure to those skilled in the art.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., managing multiple processing units) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., managing multiple processing units) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., managing multiple processing units) described herein.

Minimum risk maneuver (MRM) operation(s) may also be controlled, for example, based on one or more features (e.g., managing multiple processing units) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., managing multiple processing units) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., managing multiple processing units) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., managing multiple processing units) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

Hereinafter, one or more example embodiments of the present disclosure will be described with reference to the accompanying drawings.

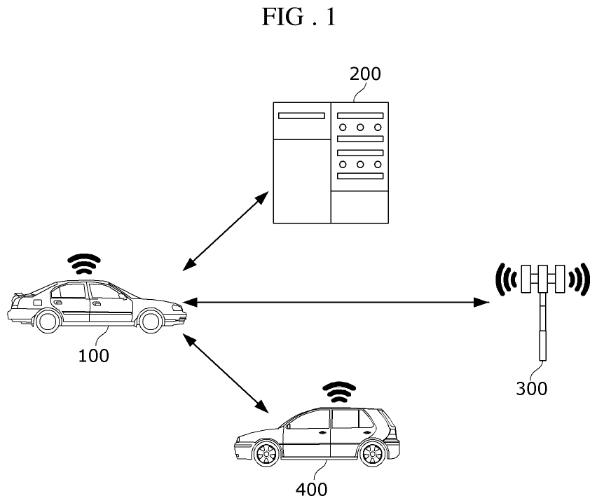

With reference to FIGS. 1 to 5, a vehicle and a server managing a vehicle controller having a plurality of processing units will be described.

FIG. 1 is a view showing an example vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas, for example, in a liquefied state. For example, the gas may be hydrogen. However, the gas is not limited thereto, and various gases are applicable. In the case of a vehicle driven based on fossil energy, the vehicle 100 is driven based on fuel such as gasoline, diesel or liquefied gas, and may be equipped with an internal combustion engine that drives an actuating unit 116 by combustion of the fuel. The engine may be included in a power source unit 114 in terms of providing a driving rotational power of wheels to a wheel driving unit (not shown) of the actuating unit 116. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. The vehicle 100 may be a robot in a broad sense, such as a means of transportation, and the robot may move using wheels, tracks, or other movement modules.

The vehicle 100 may be driven under the control of either manual driving through user operation or autonomous driving. The autonomous driving may be implemented as semi-autonomous driving or fully autonomous driving. Fully autonomous driving may be provided as autonomous movement in which a processor 122 of the vehicle 100 takes full control without user intervention, even when a driving situation is uncertain. Semi-autonomous driving may be provided as autonomous movement that requires driver intervention depending on specific driving situations. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service a driving assistance function, and may receive connected data of the vehicle 100 or transmit data necessary for manual and autonomous driving. The server 200 may transmit various pieces of information and software modules used to control the vehicle 100 to the vehicle 100 in response to requests and data transmitted from the vehicle 100 and the user device to support driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a Wi-Fi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the example embodiment(s) described herein.

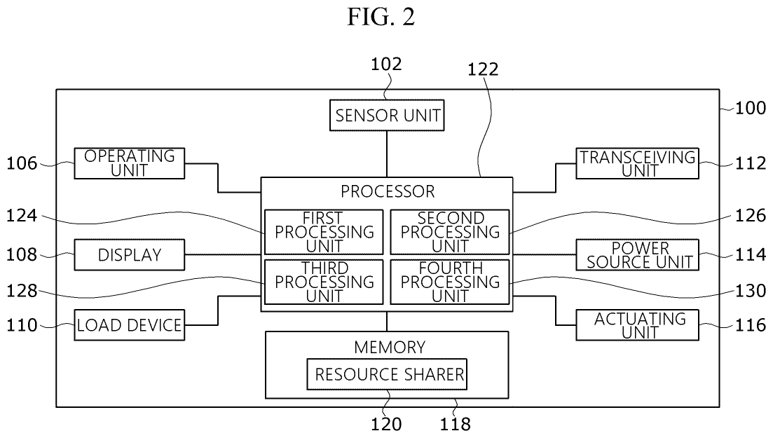

FIG. 2 is a diagram showing modules constituting an example vehicle.

The vehicle 100 may include a sensor unit 102, an operating unit 106, a display 108, a load device 110, and a transmitting/receiving unit 112.

The sensor unit 102 may be provided with various types of detectors to detect various states and situations occurring in an external environment, an internal system, a user operation, and a boarding space of the vehicle 100. The sensor unit 102 may be provided with an externally oriented camera, a lidar sensor, a radar sensor, and the like, to recognize dynamic and static objects present outside the vehicle 100. The sensor unit 102 may be provided with a positioning sensor, a wheel sensor, an attitude sensor, or the like, to confirm its own location, speed, driving attitude, and the like. A detection module for detecting various situations not listed herein may be additionally included in the sensor unit 102.

The operating unit 106 may be configured as a module that is controlled by the user for driving. For example, the operating unit 106 may be a steering wheel for manual driving, an automatic or manual shift transmission actuator, an accelerator pedal, a brake pedal, a gear shifter, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that can be touched on the display 108.

The display 108 may function as a user interface. The display 108 may output and display an operating state, a control state, route/traffic information, remaining energy amount information, content requested by the driver, or the like, of the vehicle 100 by the processor 122. In addition, the display 108 may be configured as a touch screen capable of detecting a driver's input to receive a driver's request to instruct the processor 122.

The load device (e.g., an electrical load that consumes energy) 110 is mounted on the vehicle 100 and may be a type of non-driving electrical device not including a driving power system such as the wheel driving unit 118 or the like. The load device 110 is an auxiliary device that receives electrical power from the power source unit 114, and may be, for example, an air conditioning system, an indicator lamp system, a lighting system, a seat system, various devices installed in the vehicle 100, or the like.

The transceiving unit (also referred to as a transceiver) 112 may support mutual communication with the server 200, the ITS device 300, nearby vehicles 300, and the like. The transceiving unit 112 may include a module that processes, for example, cellular communication, WAVE communication, DSRC, and the like. In the present disclosure, the transceiving unit 112 may transmit data generated or stored while driving to the server 200 and receive data and software modules transmitted from the server 200. The transceiving unit 112 may support communication with an electronic device carried by an occupant inside the vehicle 100. In the present disclosure, the vehicle 100 may transmit and receive data utilized in a method according to the present disclosure to the outside through the transmitting/receiving unit 112.

In addition, the vehicle 100 may include the power source unit 114 and the actuating unit 116.

The power source unit 114 may generate and supply power and electric power used in a driving power system such as the actuating unit 116 and a non-driving power system. The non-driving power system may be, for example, the sensor unit 102, the operating unit 106, the display 108, the load device 110, and the transmitting/receiving unit 112, but is not limited thereto, and may include various components that implement sensing, interface, communication, and convenience functions, not including components directly involved in driving operations.

When the vehicle 100 is driven based on electrical energy, the power source unit 114 may be configured as an electric battery charged from the outside, or configured as a combination of an electric battery and a fuel cell that charges the electric battery. In the case of a vehicle driven based on the combination of the electric battery and the fuel cell, the power source unit 114 may include a tank that stores materials used to produce electric power for the fuel cell, such as liquefied hydrogen. When the vehicle 100 is driven based on fossil energy, the power source unit 114 may be configured as an internal combustion engine. In addition, when the vehicle 100 is a hybrid type, the power source unit 114 may be provided as a combination of the internal combustion engine and the electric battery.

The actuating unit 116 may be provided with at least one module that implements driving operations and perform at least one driving operation among longitudinal control such as acceleration and deceleration, lateral control such as steering, and gear shifting, according to a user request from the operating unit 106 or a request from the processor 122. Gear shifting may be performed upon by a manual driving user using the gear shifter or upon a request from the processor 122 in autonomous driving.

In order to perform driving operations according to a command of the processor 122 by manual operation of the user or autonomous driving, the actuating unit 116 may be provided with the wheel driving unit (not shown) and mechanical components and electronic modules for implementing the driving operations in the wheel driving unit. If the vehicle 100 is operated based on electrical energy, the actuating unit 116 may include an assembly for transmitting the requested driving operation to the wheel driving unit 118. If the vehicle 100 is operated based on fossil energy, the actuating unit 116 may be provided with a transmission and a gear module that transmit the power of the internal combustion engine.

The wheel driving unit may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

In addition, the vehicle 100 may include a memory 118 and the processor 122.

The memory 118 may store applications and various types of data for controlling the vehicle 100, and load applications or read and record data by a request of the processor 122. The application may be executed by the processor 122 into which at least one vehicle controller (also referred to as controller, control circuit, vehicle control circuit, etc.) for performing a specific function is built. A detailed description of the vehicle controller and a plurality of processing units will be provided below.

In the present disclosure, the memory 118 may have software for managing the vehicle controller having a plurality of processing units. Specifically, the memory 118 may contain software that manages a plurality of processing units executing applications by a master processing unit, that is, a root unit. In the present disclosure, the plurality of processing units are referred to as dependent units, that is, leaf units, and the root unit may manage the leaf units. In addition, in the present disclosure, the root unit and the leaf unit may be referred to as a root complex and an end point, respectively.

The software may include processing performed by the root unit, in which a plurality of applications related to the vehicle controller are assigned to each leaf unit based on management information received from each of the leaf units. The software may include processing performed by the root unit, in which an operating mode is identified based on management information about the leaf units that execute applications, the load on the leaf units is reduced according to the operating mode, and component data of the applications is managed by a resource sharer 120.

The memory 118 may include the resource sharer 120 that stores component data for managing component data. The resource sharer 120 may be a shared memory between one or more processing units (e.g., the root unit 124, the leaf unit 126, the leaf unit 128, the leaf unit 130, etc.). The component data of the applications may include, for example, code data and application data. The code data may include executable code data of the application. The application data is data used to execute the application, and may include, for example, input/output data, log files, configuration files, and parameters used for execution.

The resource sharer 120 may have a volatile memory corresponding to a non-permanent memory and a non-volatile memory corresponding to a permanent memory. The volatile memory may be, for example, a random-access memory (RAM), such as a dynamic random-access memory (DRAM), and the non-volatile memory may be, for example, a read-only memory (ROM) and a flash memory, and the details of each memory are not limited thereto.

The resource sharer 120 may store component data of an application running on a leaf unit and delete the component data after the execution of the application is ended. Detailed data of the component data may be stored in a specific area of the resource sharer 120 depending on the type. For example, the code data may be stored in the permanent memory, and the application data may be stored in the non-permanent memory. Depending on the resource state of the leaf unit, the resource sharer 120 may not store the component data in the storage of the leaf unit, but may provide the component data to the leaf unit so that the leaf unit directly reads the component data from the resource sharer 120 when executing the application. In summary, when the storage of the leaf unit is in a resource state where the storage cannot store component data, the leaf unit may directly load the component data from the resource sharer 120 to execute the application.

The processor 122 may perform overall control of the vehicle 100. The processor 122 may be configured to execute applications and instructions stored in the memory 118.

As shown in FIG. 2, the processor 122 has a plurality of processing units 124, 126, 128, 130, and the plurality of processing units may constitute the vehicle controller that processes specific functions.

Examples of the vehicle controller may include, for example, an electric control unit (ECU), a motor control unit (MCU), a transmission control unit (TCU), a battery management system (BMS), an autonomous driving controller, an air conditioning controller, an electric drive control unit (EDCU), a vehicle communication network controller, or the like, but are not limited thereto, and may include a controller having various functions. The application may be at least one software program that processes control related to the example described above. The exemplified type of vehicle controller may process a plurality of functions related to the corresponding controller, and the vehicle controller may include the plurality of processing units 124, 126, 128, 130 for processing the plurality of functions.

Taking the ECU as an example of the vehicle controller, the vehicle controller ECU may process powertrain control, transmission control, brake control, regenerative braking control, lighting control, door lock control, safety device control, infotainment control, suspension control, and the like. The powertrain may be, for example, any one of an engine, an electric battery/motor, or a fuel cell/electric battery/motor. The ECU may include a plurality of processing units to process the detailed control described above. Each processing unit or a combination of a plurality of processing units may perform the detailed control described above.

In the present disclosure, the vehicle controller having various functions is exemplified as being mounted on a single processor 122, but the ECU, MCU, TCU, BMS, autonomous driving controller, air conditioning controller, EDCU, vehicle communication network controller, or the like may be installed in a distributed manner for each controller. For convenience of description, the present disclosure is described as having a plurality of vehicle controllers built into a virtual single processor 122, but the present disclosure may be substantially equally applied to examples in which each vehicle controller is implemented as a separate processor.

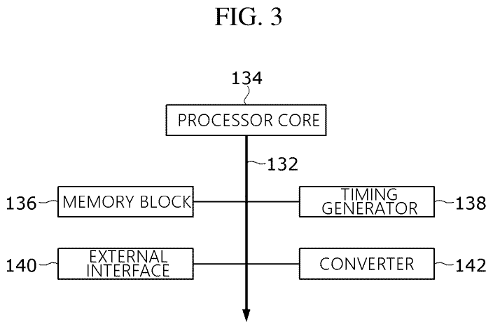

Each processing unit may be a hardware unit or a software module. As an example of the hardware unit, the processing unit may be a system on chip (SoC). The processing units 124, 126, 128, 130 include components having various functions, and as shown in FIG. 3, each of the processing units 124, 126, 128, 130 may include a processor core 134, a memory block 136, a timing generator 138, an external interface 140, and a converter 142. FIG. 3 is a view showing modules constituting an example processing unit. These components may be interconnected by a bus 132. The components of the processing units 124, 126, 128, 130 described above are examples and may further include other components.

The processor core 134 may include, for example, a central processing unit (CPU), a graphics processing unit (GPU), a neural processing unit (NPU), a microcontroller, and a digital signal processor. The processor core 134 may have a multi-core configuration. The memory block 136 may be a storage of the processing unit (e.g., local memory of the processing unit) and may have, for example, a RAM, a ROM, and a flash memory. The memory block 136 that functions as a storage may store component data according to the resource state. The code data may be stored in the ROM or flash memory, for example, and the application data may be stored in the RAM. The timing generator 138 may include, for example, a timing generator phase locked loop (PPL). The external interface 140 may include, for example, at least one of Ethernet, peripheral component interconnect express (PCIe), and a universal serial bus (USB). In addition, the bus 132 may also use various communication methods, and communication between components may be performed. The communication method of the bus 132 may be supported by, for example, Ethernet, PCIe, I3C/I2C, serial peripheral interface (SPI), or the like. The converter 142 may include, for example, an analog-to-digital converter and a digital-to-analog converter.

Each of the processing units (e.g., processors, processor cores, chiplets, etc.) 124, 126, 128, 130 may have different components and different specifications. For example, the second processing unit 126 may include a CPU, a GPU, a low-capacity RAM, and a ROM, and may support a low-speed communication method. The third processing unit 128 may include a CPU, a high-performance GPU, an NPU, a high-capacity RAM, and a high-capacity ROM, compared to the second processing unit 126, and may support a high-speed communication method. The fourth processing unit 130 may include a high-performance CPU, a GPU, an NPU, a high-capacity RAM, and a high-capacity ROM, and may support a high-speed communication method compared to the second and third processing units 126 and 128. The components and specifications of the first processing unit 124 may be the same as or different from those of the second to fourth processing units 126, 128, 130.

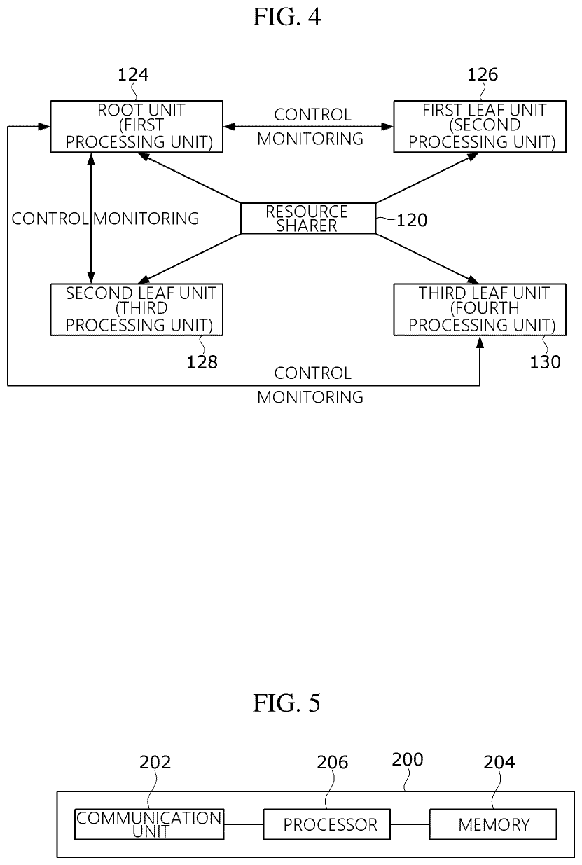

As illustrated in FIG. 4, the processor 122 may designate one processing unit 124 from among a plurality of processing units constituting a vehicle controller that processes a specific function as a root unit 124 and set other processing units 126, 128, and 130 as leaf units 126, 128, and 130. FIG. 4 is a diagram schematically showing an example scheme for management of leaf units by a root unit. Hereinafter, for convenience of description, it will be illustrated that the root unit is the first processing unit 124 and the leaf units are the second to fourth processing units 126, 128, and 130.

In order to process detailed control of the vehicle controller, for example, powertrain control of the ECU or lane keeping/collision avoidance of the autonomous driving controller, the root unit 124 may identify a plurality of applications related to detailed control in the memory 118 and search for leaf units 126, 128, 130 capable of executing the plurality of applications. The root unit 124 may assign applications to the respective retrieved leaf units 126, 128, 130, and each of the leaf units 126, 128, 130 may transmit the management information to the root unit 124 while executing the corresponding application. As shown in FIG. 4, in order for the root unit 124 to monitor the management information, each of the leaf units 126, 128, 130 may transmit the management information, and the root unit 124 may perform control of the root unit 124, which will be described below, based on the management information. In addition, like the leaf units 126, 128, 130, the root unit 124 may execute applications of detailed control. The root unit 124 may check its own management information according to the execution of the application.

The management information may include state information about the leaf units 126, 128, 130, resource information about the leaf units 126, 128, 130, and scheduling information.

The state information may include, for example, application execution data, operating state data indicating a power state or activation state, failure state data, synchronization state data related to the operating time of the leaf units, and thermal state data.

The application execution data may be data related to applications running on the leaf units 126, 128, 130 and the execution time of the applications. The power state in the operating state data may include, for example, a power off/on/boot up state from the perspective of the vehicle controller, and power off/on/reset/boot up states of the leaf units 126, 128, 130. The activation state in the operating state data may include, for example, a suspended state, a resume state, a sleep state, and an active state of the leaf units.

The failure state data may be related to a failure of a component in the leaf units 126 to 130 or an application execution interruption/execution error occurring in the leaf units 126, 128, 130. The synchronization state data may be related to operating time data of the leaf units 126, 128, 130 and to a synchronization state between the operating time of the same leaf unit 126 to 130 and a global time of the system of the vehicle controller or the entire vehicle 100. The thermal state data may be related to a thermal state induced throughout all the leaf units 126, 128, 130 and a thermal state of components of the leaf units 126, 128, 130 (e.g., the processor core 134 and the memory block 136). The thermal state data may be generated, for example, based on resource state data of the resource information. The temperature of the processor core 134 and the temperature of the memory block 136 in the resource state data may be used to generate the thermal state data.

The resource information may include performance data related to the specifications of components of the leaf units 126, 128, 130 and resource state data indicating states of the components of the leaf units 126, 128, 130 according to the execution of the application.

The performance data may include types of components and component-specific specifications. As described above, the processing units 124, 126, 128, 130 may have different components, and thus the performance data may include the types of components. The performance data related to the component-specific specifications may include unique specifications of the processor core 134, and may include, for example, allowable processing speeds of the CPU/GPU/NPU, thread types, core types, cache, clock speeds, communication bandwidth, and allowable execution speeds of the GPU memory. In addition, the performance data may include specifications unique to the memory block 136, such as the memory capacity, memory clock, channel type, transmission bandwidth, and the like.

The resource state data may include the resource state of the processor core 134 that occurs during the execution of the application. The resource state data may include, for example, processing speeds of the CPU/GPU/NPU, clock speeds, usage rates, temperature, the number of active/standby threads, cache usage/efficiency, task queue states, power consumption, load state of each core, high/low power mode, cooling operating state, data transfer speed between CPU/GPU/NPU and memory, and the like. In addition, the resource state data may include the resource state of the memory block 136 that occurs during the execution of the application. For example, the resource state data may include memory in use, available memory, memory execution speed, memory transmission bandwidth in use, channel state in use, temperature, delay time, error state, and the like.

The scheduling information may include processing scheduling of the application and scenario data of control processing of the vehicle controller for each of the leaf units 126, 128, 130. The scenario data of control processing may be planning information on tasks related to a plurality of detailed functions performed in the vehicle controller and applications performing the detailed functions. For example, the scenario data may be planning information including a sequential processing plan of a plurality of detailed functions and a plurality of applications, a parallel processing plan of at least some of the plurality of detailed functions, and a parallel processing plan of at least some of the plurality of applications. As another example, the scenario data may include planning information for performing a plurality of detailed functions and a plurality of applications of different vehicle controllers. The processing scheduling may be related to processing schedules of a plurality of applications to be executed on a single leaf unit 126, 128, or 130 that performs a plurality of detailed functions.

The processor 122 may execute processing for identifying the operating mode of the vehicle controller based on the management information using the root unit 124. Examples of the operating mode may include a resource management mode, a redundancy mode, a thermal management mode, an operational mode, and a synchronization mode. The operating mode will be described below in detail. The processor 122 may perform processing for selecting another leaf unit to execute an application based on the management information about the plurality of leaf units in response to a request for reduction of leaf units (e.g., reduction of operating leaf units) according to the operating mode using the root unit 124. The processor 122 may, using the root unit 124, load the component data of the application from the resource sharer 120 in response to the storage of the selected leaf unit 126, 128, or 130 being unavailable and perform processing to execute the application on the selected leaf unit.

FIG. 5 is a diagram showing modules constituting an example server.

The server 200 may transmit response data according to a request from the vehicle 100 to the vehicle 100, and may also transmit an application built into the vehicle 100 and information for supporting vehicle driving to the vehicle 100. The server 200 may include a communication unit 202, a memory 204, and a processor 206.

The communication unit 202 may transmit and receive data to and from an external device to support mutual communication with the vehicle 100 in the present disclosure, and may exchange data with the vehicle 100.

The memory 204 may store a program and various types of data for operating the server 200, and may load (e.g., read) programs or read and write data upon a request from the processor 206. The memory 204 may store and manage a program for processing the request from the vehicle 100, applications built into the vehicle 100, and information for driving assistance.

The processor 206 may perform overall control of the server 200. The server 200 may be configured to execute a program and instructions stored in the memory 204. The processor 206 may execute the program to process and respond to a user request transmitted from the vehicle 100.

In the present disclosure, the processor 206 is exemplified as being constituted by a single processing module. As another example, the processor 206 may be distributed into a plurality of processing modules, and the above-described processing may be executed by a distributed processing model.

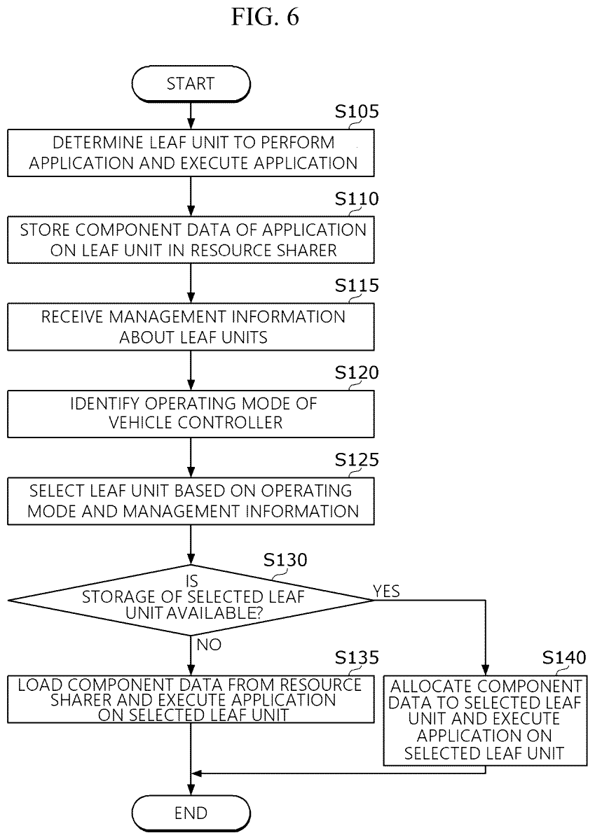

Hereinafter, with reference to FIGS. 2 to 4 and 6, a method of managing a vehicle controller having a plurality of processing units will be described in detail. FIG. 6 is a flowchart showing an example method of managing a vehicle controller having a plurality of processing units.

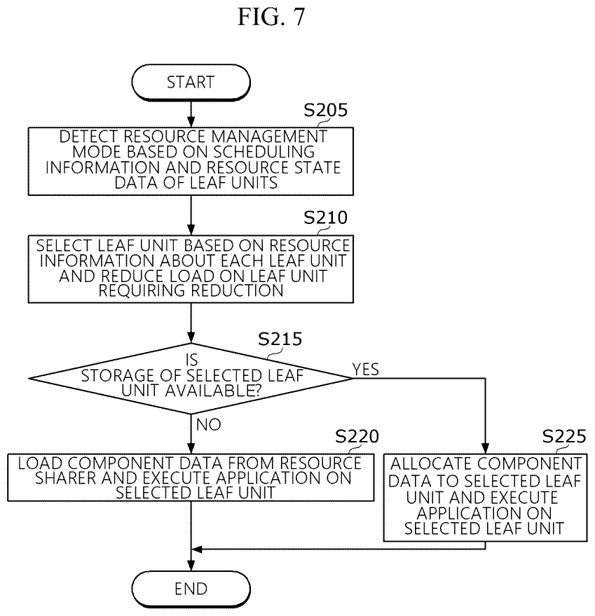

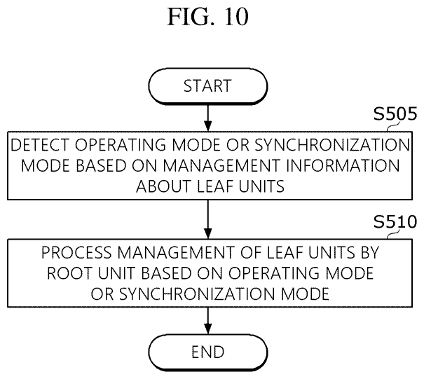

FIG. 6 shows a process common to processing in operating modes according to FIGS. 7 to 9, namely, a resource management mode, a redundancy mode, and a thermal management mode. Operations S105 to S120 in FIG. 6 may be common to the processing in the operational mode and synchronization mode, which are the operating modes according to FIG. 10. Before describing the processing of the vehicle controller for each operating mode in detail, common processing operations in the operating modes will be described through FIG. 6. In the present disclosure, a case in which a plurality of applications are processed by the vehicle controller will be exemplified. In addition, in the present disclosure, the module executing the method is mainly the root unit 124, but for convenience of description, the root unit 124, the processor 122, and the vehicle 100 may be described interchangeably.

Referring to FIG. 6, the processor 122 of the vehicle 100 may drive the vehicle controller according to a specific function request of the vehicle. The processor 122 may determine a leaf unit 126, 128, or 130 to perform a plurality of applications related to the specific function based on the management information about the leaf units 126, 128, 130 by the root unit 124 of the vehicle controller. The root unit 124 may control the determined leaf unit 126, 128, or 130 to execute the application (S105).

The root unit 124 may be designated from among a plurality of processing units by the processor 122. For example, the root unit 124 may be determined based on resource information. Specifically, the root unit 124 may be a processing unit having maximum performance data, a processing unit having performance data capable of supporting execution of software (or applications) for managing the leaf units 126, 128, 130, or a processing unit having resource state data indicating maximum resources. The performance data may be related to at least one of the example specification(s) for the processor core 134 and the memory block 136. The resource state data may be related to at least one of the resource states exemplarily listed in the processor core 134 and the memory block 136. Considering that the root unit 124 may perform an application requested from the vehicle controller, the resource state data indicating maximum resources may mean that, excluding the resources allocated to the application of the vehicle controller, the resource state is at a maximum.

The root unit 124 may determine at least one leaf unit 126, 128, 130 to perform the plurality of applications based on detailed functions and the application processing plan confirmed from the scenario data, resources to be input for the execution of the application, and the management information. The management information may include resource information about the leaf unit, state information about the leaf unit, and scheduling information. The management information is described in detail in FIG. 2, and thus the description thereof will be omitted.

The root unit 124 may assign applications to the determined leaf units 126, 128, 130, and the leaf units 126, 128, 130 may execute the assigned applications. The root unit 124 may assign at least one application to a single leaf unit 126, 128, or 130 according to the management information. In addition, the leaf units 126, 128, 130 may store component data of the assigned application in their own storages, that is, the memory block 136, and execute the application. The component data may include the code data and the application data, as described above.

The root unit 124 may control the memory 118 and the resource sharer 120 to store component data of the applications to be executed on the leaf units 126, 128, 130 in the resource sharer 120 (S110).

The code data of the component data may be stored in the permanent memory of the resource sharer 120, and the application data of the component data may be stored in the non-permanent memory of the resource sharer 120.

The root unit 124 may receive management information from the leaf units 126, 128, 130 (S115).

The root unit 124 may receive management information from any of the leaf units 126, 128, 130 executing applications and any of the leaf units 126, 128, 130 not executing applications or operating in a sleep or suspended state.

The root unit 124 may identify the operating mode of the vehicle controller and the leaf units 126, 128, 130 based on the management information (S120).

Examples of the operating mode may include a resource management mode, a redundancy mode, a thermal management mode, an operational mode, and a synchronization mode. A detailed description of the identification of each operating mode will be provided below in FIGS. 7 to 10.

The root unit 124 may select a leaf unit to execute the application based on the operating mode and management information about a plurality of leaf units 126, 128, 130 (S125).

The selection of the leaf unit 126, 128, or 130 may be performed in different ways for each operating mode, for example, the resource management mode, the redundancy mode, and the thermal management mode. A detailed description of the selection of the leaf unit 126, 128, or 130 according to the operating mode will be provided below in FIGS. 7 to 9.

In addition, the root unit 124 may generate a reduction request for the leaf unit 126, 128, or 130 related to the operating mode based on the operating mode. The operating mode in which the reduction request is required may be, for example, one of the resource management mode, the redundancy mode, and the thermal management mode. The reduction request for the leaf unit 126, 128, or 130 may be set for each operating mode and may include instructions for detailed reduction processing to reduce the load on the leaf unit 126, 128, or 130.

Specifically, the reduction request may be set for each of the resource management mode, the redundancy mode, and the thermal management mode. In the resource management mode, the reduction request may include processing for executing another application. Examples of the execution of another application may include reduction processing for executing another application in place of an application that is being executed or scheduled to be executed, or executing an application that requires fewer resources than the running application based on changes in scheduling information. In addition, the reduction request may include reduction processing for operating the leaf unit 126, 128, or 130 by reducing at least a portion of the component data of the leaf unit 126, 128, or 130 for which resource management is required. Reduction of components in the leaf unit 126, 128, or 130 may include processing for deleting at least some of the code data and application data stored in the memory block 136 of the leaf unit 126, 128, or 130, transferring the deleted component data to another leaf unit 126, 128, or 130 or using the component data of the resource sharer 120. The reduction request may include reduction processing for deactivating the leaf unit 126, 128, or 130 by removing component data of the leaf unit 126, 128, or 130.

In the redundancy mode, the reduction request may include reduction processing for deactivating the leaf unit 126, 128, or 130 by removing the component data of the leaf unit 126, 128, or 130 in which a failure is caused. In the thermal management mode, the reduction request may include reduction processing for running another application on a heat-generating leaf unit 126, 128, or 130, deactivating the leaf unit 126, 128, or 130 by removing component data of the heat-generating leaf unit126, 128, or 130, or operating the leaf unit 126, 128, or 130 by reducing at least a portion of the component data of the heat-generating leaf unit 126, 128, or 130.

The root unit 124 may perform load reduction on a leaf unit 126, 128, or 130 related to the corresponding operating mode based on the reduction request according to the operating mode. The leaf unit 126, 128, or 130 requiring reduction may execute reduction processing based on the reduction request. The load reduction may be an operation related to the reduction processing described above for each operating mode.

The root unit 124 may determine whether the storage of the selected leaf unit 126, 128, or 130 is available (e.g., usable, sufficient, etc.) as a storage space for component data (S130).

The root unit 124 may determine whether to use the memory block 136 of the leaf unit 126, 128, or 130 based on the resources to be input for the application and resource information related to the memory block 136 of the selected leaf unit 126, 128, or 130. For example, the resource information related to the memory block 136 may include current available memory, current memory execution speed, used transmission bandwidth, delay time, and the like.

If the storage (e.g., local storage or local memory) of the selected leaf unit 126, 128, or 130 is unavailable, the root unit 124 may control the selected leaf unit 126, 128, or 130 to directly load (e.g., read) the component data of the application from the resource sharer 120 (e.g., control the component data of the application be loaded or read from the resource sharer 120 to the selected leaf unit 126, 128, or 130) based on the storage (e.g., local storage or local memory) of the selected leaf unit 126, 128, or 130 being unavailable (e.g., unusable, insufficient, etc.), and execute the application on the selected leaf unit 126, 128, or 130 (S135).

Direct loading (e.g., direct reading) may mean that the selected leaf unit 126, 128, or 130 directly reads the component data from the resource sharer 120 and executes the application without storing the component data in the storage (e.g., local storage or local memory) of the selected leaf unit 126, 128, or 130.

If the storage of the selected leaf unit 126, 128, or 130 is available (e.g., unused space exists), the root unit 124 may control the selected leaf unit 126, 128, or 130 to allocate component data to the selected leaf unit 126, 128, or 130 based on the storage (e.g., local storage or local memory) being available (e.g., sufficient) for use, store the component data in the storage of the selected leaf unit, and execute the application of the storage on the selected leaf unit 126, 128, or 130 (S140).

As one example, all component data may be stored in the memory block 136 of the selected leaf unit 126, 128, or 130. As another example, depending on the resource information related to the memory block 136, a portion of the component data may be stored in the memory block 136 of the selected leaf unit 126, 128, or 130, and another portion of the component data may be directly loaded (e.g., read) from the resource sharer 120. For example, code data may be stored in the memory block 136 of the leaf unit 126, 128, or 130, and the application data may be held in the resource sharer 120.

With reference to FIGS. 2 to 4 and FIGS. 7 to 9, the processing processes of the vehicle controller will be described separately for each operating mode.

FIG. 7 is a flowchart showing an example process for the vehicle controller in the resource management mode.

The root unit 124 may detect the resource management mode by identifying a leaf unit 126, 128, or 130 requiring reduction based on the scheduling information or the resource state data of the leaf units 126, 128, 130 in the management information about the leaf units 126, 128, 130 acquired in operation S115 in FIG. 6 (S205).

Operation S205 according to the resource management mode may be a process corresponding to operation S120 in FIG. 6.

In relation to the detection of the resource management mode by the scheduling information, the scheduling information used to detect the resource management mode may include scenario data and processing scheduling. The root unit 124 may detect that the vehicle controller will enter the resource management mode based on the reception of new scheduling information or a change in scheduling information during the execution of an application on at least one leaf unit 126, 128, 130.

In relation to the detection of the resource management mode by the resource state data, the root unit 124 may detect the resource management mode based on resource state data in which at least one of states of a plurality of components in each of the leaf units 126, 128, 130 indicates an unstable condition. For convenience of description, the first leaf unit 126 is illustrated as having unstable resource state data. If the processing speed, usage rate, core load state, and transmission speed of the processor core 134 in the first leaf unit 126 fluctuate beyond a threshold value, indicating an unstable condition, the root unit 124 may detect a resource management mode due to the first leaf unit 126. As another example, when the available memory, execution speed, and used transmission bandwidth of the memory block 136 in the first leaf unit 126 fluctuate beyond a threshold value, indicating an unstable condition, the root unit 124 may detect a resource management mode due to the first leaf unit 126.

The root unit 124 selects a leaf unit 126, 128, or 130 based on resource information about each of the leaf units 126, 128, 130, and may control the leaf unit 126, 128, or 130 to reduce the load on the leaf unit requiring reduction (S210).

Operation S210 according to the resource management mode may be a process corresponding to operation S125 in FIG. 6.

In relation to the selection of the leaf unit by the scheduling information, the root unit 124 may select, from among a plurality of leaf units 126, 128, 130, leaf units having performance data capable of supporting the execution of an application defined in the scheduling information, and, from among the selected leaf units, select a leaf unit having resource state data indicating maximum resources.

In relation to the selection of the leaf unit by the scheduling information, the scenario data includes sequential execution of a first application and a second application related to a specific detailed function of the ECU, and an example in which the processing scheduling of the third leaf unit 130 shown in FIG. 3 sequentially executes the first application and the second application is described.

The scenario data may be changed to require processing of a third application that involves processing by the NPU. Accordingly, the root unit 124 may change the processing scheduling to cause the third leaf unit 130 to execute the third application based on the performance data and resource state data required by the third application. Specifically, the root unit may select the second and third leaf units 130 equipped with NPUs, and among the second and third leaf units 128 and 130, determine the third leaf unit 130 having high performance data and/or resource state data having maximum resources as the leaf unit to execute the third application.

The root unit 124 may determine whether the third leaf unit 130 can process all of the second and third applications scheduled to be executed based on the management information. For example, when the resource state data has a resource state of the processor core 134 that cannot fully execute the second and third applications, or when the component data of both applications is not fully stored in the memory block 136 of the third leaf unit 130, it may be determined that the third leaf unit 130 cannot fully process the second and third applications.

According to the above description, the third leaf unit 130 is determined as a leaf unit requiring reduction, and the root unit 124 may generate a reduction request for the selected leaf unit, that is, the third leaf unit 130. By the reduction request, processing for reducing the load on the third leaf unit 130 that will execute the third application may be performed.

For example, in order to reduce the load on the third leaf unit 130, the root unit 124 may control the third leaf unit 130 to stop the execution of the second application and delete component data of the second application from the memory block 136 of the third leaf unit 130.

When execution of the second application is required, the root unit 124 may select a leaf unit to execute the second application from among a plurality of leaf units 126 and 128 based on the management information. For example, when the second leaf unit 128 is selected as the leaf unit to execute the second application, the root unit 124 may control the leaf units 126, 128, 130 to execute the second application on the second leaf unit 128. The second leaf unit 128 may access component data through the storage of the second leaf unit 128 to which the component data of the second application is transferred. As another example, in order to reduce the resource load, the second leaf unit 128 may access the component data through the resource sharer 120 without storing at least a portion of the component data.

In the case of the resource management mode due to unstable resource state data, the root unit 124 may determine, from among a plurality of leaf units 126, 128, 130, another leaf unit 126, 128, or 130 having resource state data indicating maximum resources as the leaf unit to execute the application of the first leaf unit 126, based on the management information.

The root unit 124 may generate a reduction request (e.g., load reduction request) according to the resource management mode and perform processing for reducing the load on the first leaf unit 126 based on the reduction request. For example, the root unit 124 may control the leaf units 126, 128, 130 to keep the first leaf unit 126 active so that another application that requires fewer resources than the original application may be executed on the first leaf unit 126. To further reduce the load, the root unit 124 may store at least a portion of component data of the other application in the resource sharer 120, so that the first leaf unit 126 may access the component data through the resource sharer 120. As another example, the root unit 124 may control the leaf units 126, 128, 130 to operate the first leaf unit 126 in a deactivated state.

The root unit 124 may determine whether the storage of the selected leaf unit 126, 128, or 130 is available (e.g., usable, sufficient, etc.) as a storage space for component data (S215).

Operations S215 to S225 according to the resource management mode may be processes corresponding to operations S130 to S140 in FIG. 6.

The root unit 124 may determine whether to use the memory block 136 of the leaf unit 126, 128, or 130 based on the resources to be input for the application and resource information related to the memory block 136 of the leaf unit 126, 128, or 130 in operation S210. The example of the resource information related to the memory block 136 is described above in operation S130, and thus the description thereof will be omitted.

When the storage of the selected leaf unit 126, 128, or 130 is unavailable, the root unit 124 may control the selected leaf unit 126, 128, or 130 to directly load the component data of the application from the resource sharer 120 based on the unavailable storage (e.g., based on the local memory being unavailable or insufficient) and execute the application on the selected leaf unit 126, 128, or 130 (S220).

When the storage of the selected leaf unit 126, 128, or 130 is available, the root unit 124 may control the selected leaf unit 126, 128, or 130 to allocate component data to the selected leaf unit 126, 128, or 130 based on the availability of the storage (e.g., local storage or local memory), store the component data in the storage of the selected leaf units, and execute the application of the storage on the selected leaf unit 126, 128, or 130 (S225). Operations S220 and S225 are described above in operations S135 and S140, and thus the description thereof will be omitted.

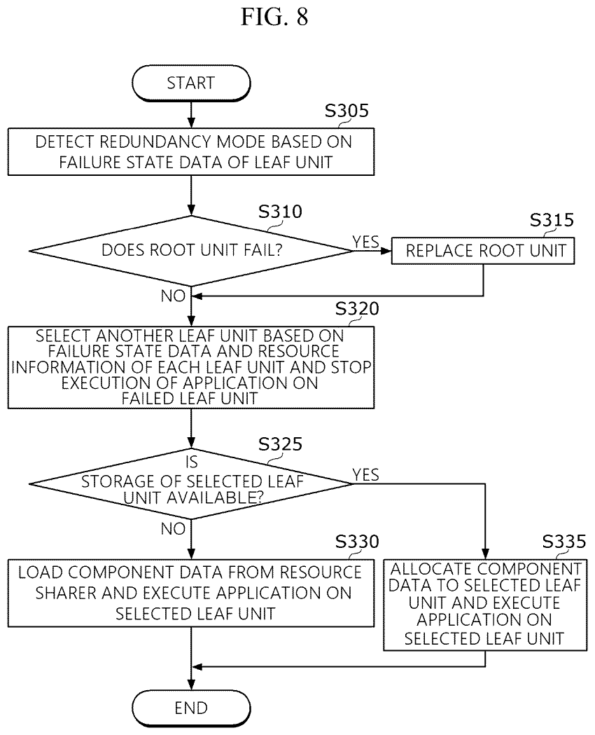

FIG. 8 is a flowchart showing an example process for the vehicle controller in the redundancy mode.

The root unit 124 may detect the redundancy mode by identifying a failed leaf unit based on the failure state data in the management information about the leaf units 126, 128, 130 acquired in operation S115 in FIG. 6 (S305).

Operation S305 according to the redundancy mode may be a process corresponding to operation S120 in FIG. 6.

For example, the root unit 124 may receive failure state data from each of the leaf units 126, 128, 130 and identify a leaf unit 126, 128, or 130 in which a component failure occurs or an application execution interruption/execution error occurs as a failed leaf unit. The failure state data may further include information on whether a power-off or reset of the leaf unit is required due to a component failure or an execution error. As another example, when the root unit 124 receives failure state data requiring a power off or reset due to a failure, the root unit 124 may determine that a leaf unit related to the received failure state data is a failed leaf unit.

The root unit 124 or the processor 122 may determine whether the root unit fails based on the failure state data of the root unit (S310). The failure state data may be substantially identical to that described in operation S305.

When the root unit 124 fails, the processor 122 may replace the root unit 124 by determining one of a plurality of leaf units in a normal state as the root unit based on the failure of the root unit 124 and the management information about the leaf units 126, 128, 130 (S315). The determination of the root unit 124 for replacement may be similar to the selection of the root unit described in operation S105, except that the root unit is selected from the leaf units in a normal state.

When the root unit 124 is replaced, operations S320 to S335, which will be described below, are performed by the replaced root unit, and when the root unit 124 is in a normal state and is not replaced, operations S320 to S335 may be performed by the same root unit 124. For convenience of description, in the following, the root unit 124 will be referred to as such, regardless of whether the root unit 124 is replaced or not replaced.

The root unit 124 selects a failed leaf unit and other leaf units 126, 128, 130 based on the failure state data and resource information of each of the leaf units126, 128, 130, and may stop the execution of the application on the failed leaf unit (S320).

Operation S320 according to the redundancy mode may be a process corresponding to operation S125 in FIG. 6.

The root unit 124 may select a leaf unit whose performance data has a predetermined similarity to that of the failed leaf unit from among a plurality of leaf units in the normal state. This may be to allow the application from the failed leaf unit to be seamlessly processed by another leaf unit. For example, when the application of the failed leaf unit requires processing using an NPU or high-capacity RAM, the root unit 124 may select leaf units 126, 128, 130 having performance data that include the components and specifications described above. Subsequently, the root unit 124 may select, from among the selected leaf units, a leaf unit having resource state data indicating maximum resources as a leaf unit to execute the application.

The root unit 124 may generate a reduction request (also referred to as a load reduction request) for the failed leaf unit. By the reduction request (e.g., based on receiving the reduction request), the failed leaf unit may stop executing the application and operate in a deactivated state.

The root unit 124 may determine whether the storage of the selected leaf unit 126, 128, or 130 is available (e.g., usable, sufficient, etc.) as a storage space for component data (S325). When the storage of the selected leaf unit 126, 128, or 130 is unavailable, the root unit 124 may control the selected leaf units 126, 128, 130 to directly load the component data of the application from the resource sharer 120 based on the unused storage and execute the application on the selected leaf unit 126, 128, or 130 (S330). When the storage of the selected leaf unit 126, 128, or 130 is available, the root unit 124 may control the selected leaf unit 126, 128, or 130 to allocate component data to the selected leaf unit 126, 128, or 130 based on the availability of the storage, store the component data in the storage of the selected leaf unit, and execute the application of the storage on the selected leaf unit 126, 128, or 130 (S335). Since operations S325 to S335 according to the redundancy mode correspond to operations S130 to S140 of FIG. 6, the detailed description thereof will be omitted.

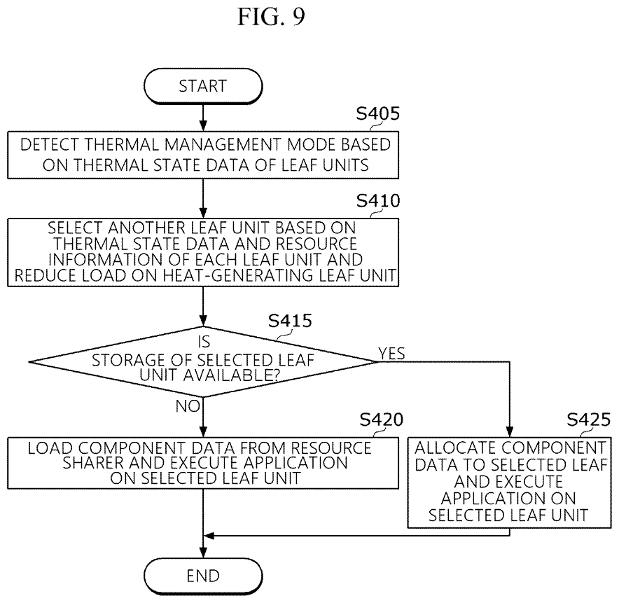

FIG. 9 is a flowchart showing an example process for the vehicle controller in the thermal management mode.

The root unit 124 may detect the thermal management mode by identifying a heat-generating leaf unit based on the thermal state data in the management information about the leaf units 126, 128, 130 acquired in operation S115 in FIG. 6 (S405).

Operation S405 according to the thermal management mode may be a process corresponding to operation S120 in FIG. 6.

For example, the root unit 124 may receive the thermal state data from each of the leaf units 126, 128, 130 and identify a leaf unit 126, 128, or 130 that exceeds a reference thermal state as the heat-generating leaf unit. The thermal state data may be related to a thermal state induced in the entire leaf unit 126, 128, or 130 and a thermal state of components of the leaf unit 126, 128, or 130 (e.g., the processor core 134 and the memory block 136). The thermal state data may be generated based on, for example, resource state data. The temperature of the processor core 134 and the temperature of the memory block 136 in the resource state data may be used to generate the thermal state data.

The root unit 124 may select a heat-generating leaf unit and other leaf units 126, 128, 130 based on the thermal state data and the resource information about each of the leaf units 126, 128, 130, and perform processing for reducing the load on the heat-generating leaf unit (S410).

Operation S410 according to the thermal management mode may be a process corresponding to operation S125 in FIG. 6.

The root unit 124 may select a leaf unit having performance data that has a predetermined similarity to the heat-generating leaf unit from among a plurality of leaf units having a reference thermal state or lower. This may be to allow the application from the heat-generating leaf unit to be seamlessly processed by another leaf unit. For example, when the application of the heat-generating leaf unit requires processing using an NPU or high-capacity RAM, the root unit 124 may select leaf units 126, 128, 130 having performance data that include the components and specifications described above. Subsequently, the root unit 124 may select, from among the selected leaf units, a leaf unit having resource state data indicating maximum resources as a leaf unit to execute the application.

The root unit 124 may generate a reduction request (e.g., load reduction request) for the heat-generating leaf unit. As one example, by the reduction request, the heat-generating leaf unit may operate in a deactivated state after removing component data of the application. As another example, when it is determined that the thermal state is reduced or an application having a low resource load may be executed based on the thermal state data, state information, and resource information of the heat-generating leaf unit, the root unit 124 may designate the heat-generating leaf unit as an active state. The heat-generating leaf unit in the active state may execute an application assigned by the root unit 124. In addition, to further reduce the load, the heat-generating leaf unit 126, 128, or 130 may process the application by directly loading at least a portion of the component data from the resource sharer 120 by the reduction request.

The root unit 124 may determine whether the storage of the selected leaf unit 126, 128, or 130 is available (e.g., usable, sufficient, etc.) as a storage space for component data (S415). When the storage of the selected leaf unit 126, 128, or 130 is unavailable, the root unit 124 may control the selected leaf units 126, 128, 130 to directly load the component data of the application from the resource sharer 120 based on the unavailable (e.g., insufficient) storage and execute the application on the selected leaf unit 126, 128, or 130 (S420). If the storage of the selected leaf unit 126, 128, or 130 is available, the root unit 124 may control the selected leaf unit 126, 128, or 130 to allocate component data to the selected leaf unit 126, 128, or 130 based on the availability of the storage, store the component data in the storage of the selected leaf unit, and execute the application of the storage on the selected leaf unit 126, 128, or 130 (S425). Since operations S415 to S425 according to the thermal management mode correspond to operations S130 to S140 of FIG. 6, the detailed description thereof will be omitted.

FIG. 10 is a flowchart showing an example process for the vehicle controller in the operational mode and the synchronization mode.

The root unit 124 may detect the operational mode or the synchronization mode based on the management information about the leaf units 126, 128, 130 (S505).

In relation to the operational mode, the root unit 124 may detect the operational mode of the vehicle controller based on, for example, management information, resource information, operating state data, failure state data, and thermal state data. The operating state data may include a power state and an activation state. The power state may include, for example, a power off/on/boot up state from the perspective of the vehicle controller, and power off/on/reset/boot up states of the leaf units 126, 128, 130. The activation state may include, for example, a suspended state, a resume state, a sleep state, and an active state of a leaf unit.

In order to execute an application requested in the scheduling information, the root unit 124 may determine whether the application may be assigned to a leaf unit 126, 128, or 130 based on the above-described information and data in the leaf unit 126, 128, or 130 that is powered off or operating in a sleep state. Alternatively, the root unit 124 may stop the application in the leaf unit 126, 128, or 130 and determine whether to power off or operate the leaf unit 126, 128, or 130 in a sleep mode based on the information and data described above in the leaf unit 126, 128, or 130 executing the application.

The root unit 124 may generate a change request between the power off/sleep state and the power on/active state based on the determination. That is, the root unit 124 may detect the operational mode according to a request for change in the operating state data.

In relation to the synchronization mode, the root unit 124 may detect the synchronization mode of the vehicle controller based on, for example, the synchronization state data of each of the leaf units 126, 128, 130. The synchronization state data may be related to, for example, operating time data of a leaf unit 126, 128, or 130 and to a synchronization state between the operating time of the same leaf unit 126, 128, or 130 and a global time of the system of the vehicle controller or the entire vehicle 100. When the synchronization state data of at least one of the leaf units 126, 128, 130 is different, the root unit 124 may detect the synchronization mode.

The root unit 124 may process management of the leaf units 126, 128, 130 based on the operational mode or the synchronization mode (S510).

In the case of the operational mode, the root unit 124 may perform processing for changing the operating state data of the corresponding leaf unit 126, 128, or 130. For example, the change processing includes a transition between power-off/sleep states and power-on/active states, and is not limited to the examples described above when the change is a change in data included in the operating state data. In the case of the synchronization mode, the root unit 124 may perform processing for synchronizing the synchronization state data of the plurality of leaf units 126, 128, 130.

According to the present disclosure, it is possible to provide a method of managing a vehicle controller for efficiently and stably managing a plurality of processing units built into the vehicle controller in terms of resources and operating states and a vehicle.

The effects obtainable from the present disclosure are not limited to the effects mentioned above, and other effects not mentioned may be clearly understood by those of ordinary skill in the art to which the present disclosure belongs from the following description.

While the example method(s) of the present disclosure described above are

represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The one or more example embodiment(s) of the present disclosure are not a list of all possible combinations and are intended to describe representative aspects of the present disclosure, and the matters described in the example embodiment(s) may be applied independently or in combination of two or more.

In addition, one or more example embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of example embodiment(s) to be executed on an apparatus or a computer, a non-transitory computer-readable medium having such software or commands stored thereon and executable on the apparatus or the computer.

According to the present disclosure, there is provided a method of managing a vehicle controller having a plurality of processing units, the method comprising: receiving, by a root unit that manages a plurality of leaf units, management information about at least one leaf unit executing an application for vehicle control; identifying, by the root unit, an operating mode of the vehicle controller based on the management information; selecting, by the root unit, a leaf unit to execute the application based on the operating mode and the management information about the plurality of leaf units; and loading, by the root unit, component data of the application from a resource sharer in response to unused storage of the selected leaf unit, and executing the application on the selected leaf unit.

According to the present disclosure in the method, the method may further comprise allocating, by the root unit, the component data to the selected leaf unit to be stored in the selected leaf unit in response to use of the storage of the selected leaf unit and executing the application on the selected leaf unit.

According to the present disclosure in the method, the selecting of the leaf unit may further include generating a reduction request for the leaf unit related to the operating mode, the reduction request may be set for each operating mode, and the reduction request for the leaf unit may include controlling the leaf unit to execute another application on the leaf unit, to deactivate the leaf unit by removing the component data of the leaf unit, or to operate the leaf unit by reducing at least a portion of the component data of the application.

According to the present disclosure in the method, the management information may include state information about the leaf unit, resource information about the leaf unit, and scheduling information and the state information may include application execution data, operating state data indicating a power state or an activation state, failure state data, synchronization state data related to an operation time of the leaf unit, and thermal state data. The resource information may include performance data related to a type of a component of the leaf unit and specifications of the component, and resource state data indicating a state of the component of the leaf unit according to execution of the application, and the scheduling information may include processing scheduling of the application and scenario data of control processing of the vehicle controller for each leaf unit.

According to the present disclosure in the method, the identifying of the operating mode may include detecting a resource management mode by identifying the leaf unit requiring reduction based on the scheduling information or the resource state data, and the selecting of the leaf unit may include selecting the leaf unit based on the resource information about each of the leaf units and controlling the leaf unit to reduce a load on the leaf unit requiring reduction.

According to the present disclosure in the method, the selecting of the leaf unit may include selecting leaf units having performance data capable of supporting execution of an application defined in the scheduling information from among the plurality of leaf units, in response to the resource management mode being identified by the scheduling information, selecting a leaf unit having resource state data indicating maximum resources from among the selected leaf units, and reducing the load on the selected leaf unit.

According to the present disclosure in the method, the selecting of the leaf unit may include selecting another leaf unit having resource state data indicating maximum resources from among the plurality of leaf units in response to the resource management mode being identified by the resource state data, and the resource management mode may be identified based on the resource state data in which at least one of states of a plurality of components in the leaf unit executing the application indicates an unstable condition.

According to the present disclosure in the method, the identifying of the operating mode may include detecting a redundancy mode by identifying a failed leaf unit based on the failure state data. The selecting of the leaf unit may include selecting a leaf unit other than the failed leaf unit based on the failure state data and the resource information about each of the leaf units. Also, the selecting of the leaf unit may include selecting leaf units having performance data having a predetermined similarity with the failed leaf unit from among a plurality of leaf units in a normal state and selecting a leaf unit having resource state data indicating maximum resources, from among the selected leaf units.

According to the present disclosure in the method, the method may further comprise: prior to the selecting of the leaf unit, determining whether the root unit fails based on the failure state data about the root unit; and replacing the root unit by determining one of the plurality of leaf units in the normal state as the root unit based on the failure of the root unit. The selecting of the leaf unit and the executing of the application are performed by the replaced root unit.

According to the present disclosure in the method, the identifying of the operating mode may include detecting a thermal management mode by identifying a heat-generating leaf unit based on the thermal state data. The selecting of the leaf unit may include selecting a leaf unit other than the heat-generating leaf unit based on the thermal state data and the resource information about each of the leaf units. Also, the selecting of the leaf unit may include selecting leaf units having performance data having a predetermined similarity to the heat-generating leaf unit from among leaf units having a reference thermal state or lower and selecting a leaf unit having resource state data indicating maximum resources, from among the selected leaf units.

According to the present disclosure, there is provided a vehicle that manages a vehicle controller having a plurality of processing units, the vehicle comprising: a memory configured to store at least one instruction and including a resource sharer; and at least one processor configured to execute the at least one instruction stored in the memory and including a vehicle controller having a root unit and a plurality of leaf units managed by the root unit. The at least one processor is configured to: receive, by the root unit, management information about at least one leaf unit executing an application for vehicle control; identify, by the root unit, an operating mode of the vehicle controller based on the management information; select, by the root unit, a leaf unit to execute the application based on the operating mode and the management information about the plurality of leaf units; and load, by the root unit, component data of the application from the resource sharer in response to unused storage of the selected leaf unit and execute the application on the selected leaf unit.

What is claimed is:

1. A method comprising:
receiving, by a root processor in a vehicle control circuit of a vehicle, management information of a plurality of leaf processors, in the vehicle control circuit, configured to execute an application for vehicle control of the vehicle, wherein the root processor manages the plurality of leaf processors;
identifying, by the root processor and based on the management information, an operating mode of the vehicle control circuit;
selecting, by the root processor and based on the operating mode and the management information, a first leaf processor, of the plurality of leaf processors, for executing the application; and
causing, by the root processor and based on a local memory of the first leaf processor being unavailable, the first leaf processor to:
read component data, of the application, from a shared memory that is shared between the root processor and the plurality of leaf processors; and
execute the application.

2. The method of claim 1, further comprising causing, by the root processor and based on the local memory of the first leaf processor being available:
the component data to be stored in the local memory of the first leaf processor; and
the first leaf processor to read the component data from the local memory of the first leaf processor and execute the application.

3. The method of claim 1, wherein the selecting of the first leaf processor comprises generating a load reduction request for the first leaf processor, wherein the first leaf processor is associated with the operating mode,
wherein the load reduction request is based on the operating mode, and
wherein the load reduction request for the first leaf processor comprises at least one of:
controlling the first leaf processor to execute another application on the first leaf processor;
deactivating the first leaf processor by removing the component data from the local memory of the first leaf processor; or
controlling the first leaf processor to reduce at least a portion of the component data stored in the local memory of the first leaf processor.

4. The method of claim 1, wherein the management information comprises: state information of the plurality of leaf processors, resource information of the plurality of leaf processors, and scheduling information of the plurality of leaf processors,
wherein the state information comprises at least one of:
application execution data of each of the plurality of leaf processors,
operating state data indicating a power state or an activation state of each of the plurality of leaf processors,
failure state data of each of the plurality of leaf processors,
synchronization state data associated with an operation time of each of the plurality of leaf processors, or thermal state data of each of the plurality of leaf processors,
wherein the resource information comprises at least one of:
performance data related to a type of a component of each of the plurality of leaf processors and specifications of the component, or
resource state data indicating a state of the component of each of the plurality of leaf processors according to execution of the application, and
wherein the scheduling information comprises at least one of:
processing scheduling of the application, or
scenario data of control processing of the vehicle control circuit for each leaf processor of the plurality of leaf processors.

5. The method of claim 4, wherein the identifying of the operating mode comprises identifying a resource management mode by determining, based on the scheduling information or the resource state data, that the first leaf processor requires load reduction, and
wherein the selecting of the first leaf processor comprises:
selecting the first leaf processor further based on the resource information of each of the plurality of leaf processors; and
controlling the first leaf processor to reduce load.

6. The method of claim 5, wherein the selecting of the first leaf processor comprises:
selecting, based on the resource management mode being identified according to the scheduling information, one or more leaf processor candidates, of the plurality of leaf processors, that have performance data capable of supporting execution of the application defined in the scheduling information;
selecting the first leaf processor, of the one or more leaf processor candidates, that has resource state data indicating maximum resources; and
controlling the first leaf processor to reduce load.

7. The method of claim 5, wherein the selecting of the first leaf processor comprises:
selecting, based on the resource management mode being identified according to the resource state data, another leaf processor, of the plurality of leaf processors, that has resource state data indicating maximum resources, and
wherein the resource management mode is identified based on the resource state data indicating that at least one state, of states of a plurality of components in the first leaf processor executing the application, indicates an unstable condition.

8. The method of claim 4, wherein the identifying of the operating mode comprises detecting a redundancy mode by identifying, based on the failure state data, a failed leaf processor of the plurality of leaf processors,
wherein the selecting of the first leaf processor comprises selecting a leaf processor, of the plurality of leaf processors and other than the failed leaf processor, based on the failure state data and the resource information of each of the plurality of leaf processors, and
wherein the selecting of the first leaf processor further comprises:
selecting one or more leaf processor candidates, of the plurality of leaf processors, that have performance data indicating a predetermined similarity with the failed leaf processor in a normal state; and
selecting the first leaf processor, of the one or more leaf processor candidates, that has resource state data indicating maximum resources.

9. The method of claim 8, further comprising, prior to the selecting of the first leaf processor:
determining, based on the failure state data of the root processor, whether the root processor fails; and
replacing, based on a failure of the root processor, the root processor by determining one of the plurality of leaf processors in the normal state as a replacement root processor,
wherein the selecting of the first leaf processor and the causing the first leaf processor to execute the application are performed by the replacement root processor.

10. The method of claim 4, wherein the identifying of the operating mode comprises detecting a thermal management mode by identifying, based on the thermal state data, a heat-generating leaf processor,
wherein the selecting of the first leaf processor comprises selecting, based on the thermal state data and the resource information of each of the plurality of leaf processors, a leaf processor other than the heat-generating leaf processor, and
wherein the selecting of the first leaf processor further comprises:
selecting one or more leaf processor candidates, from among one or more leaf processors having a reference thermal state or lower, having performance data having a predetermined similarity to the heat-generating leaf processor; and
selecting the first leaf processor, of the one or more leaf processor candidates, that has resource state data indicating maximum resources.

11. A vehicle comprising:
a plurality of leaf processors configured to execute an application for vehicle control of the vehicle;
a root processor configured to manage the plurality of leaf processors;
a memory comprising:
a shared memory that is shared by the root processor and the plurality of leaf processors; and
a local memory for each leaf processor of the plurality of leaf processors,
wherein the memory stores at least one instruction that is configured, when executed by the root processor, to cause a control circuit of the vehicle to:
receive management information of the plurality of leaf processors;
identify, based on the management information, an operating mode of the control circuit;
select, based on the operating mode and the management information, a first leaf processor, of the plurality of leaf processors, for executing the application; and
cause, based on the local memory of the first leaf processor being unavailable, the first leaf processor to:
read component data, of the application, from the shared memory; and
execute the application.

12. The vehicle of claim 11, wherein the at least one instruction is configured, when executed by the root processor, to further cause the control circuit to cause, based on the local memory of the first leaf processor being available:
the component data to be stored in the local memory of the first leaf processor; and
the first leaf processor to read the component data from the local memory of the first leaf processor and execute the application.

13. The vehicle of claim 11, wherein the at least one instruction is configured, when executed by the root processor, to cause the control circuit to select the first leaf processor by generating a load reduction request for the first leaf processor, wherein the first leaf processor is associated with the operating mode,
wherein the load reduction request for the first leaf processor is based on the operating mode, and
wherein the load reduction request comprises at least one of:
controlling the first leaf processor to execute another application on the first leaf processor;
deactivating the first leaf processor by removing the component data from the local memory of the first leaf processor; or
controlling the first leaf processor to reduce at least a portion of the component data stored in the local memory of the first leaf processor.

14. The vehicle of claim 11, wherein the management information comprises: state information of the plurality of leaf processors, resource information of the plurality of leaf processors, and scheduling information of the plurality of leaf processors,
wherein the state information comprises at least one of:
application execution data of each of the plurality of leaf processors,
operating state data indicating a power state or an activation state of each of the plurality of leaf processors,
failure state data of each of the plurality of leaf processors,
synchronization state data associated with an operation time of each of the plurality of leaf processors, or
thermal state data of each of the plurality of leaf processors,
wherein the resource information comprises at least one of:
performance data related to specifications of a component of each of the plurality of leaf processors, or
resource state data indicating a state of the component of each of the plurality of leaf processors according to execution of the application, and
wherein the scheduling information comprises at least one of:
processing scheduling of the application, or
scenario data of control processing of the control circuit for each leaf processor of the plurality of leaf processors.

15. The vehicle of claim 14, wherein the at least one instruction is configured, when executed by the root processor, to cause the control circuit to identify the operating mode by identifying a resource management mode by determining, based on the scheduling information or the resource state data, that the first leaf processor requires load reduction, and
wherein the at least one instruction is configured, when executed by the root processor, to cause the control circuit to select the first leaf processor by:
selecting the first leaf processor further based on the resource information of each of the plurality of leaf processors; and
controlling the first leaf processor to reduce load.

16. The vehicle of claim 15, wherein the at least one instruction is configured, when executed by the root processor, to cause the control circuit to select the first leaf processor by:
selecting, based on the resource management mode being identified according to the scheduling information, one or more leaf processor candidates, of the plurality of leaf processors, that have performance data capable of supporting execution of the application defined in the scheduling information;
selecting the first leaf processor, of the one or more leaf processor candidates, that has resource state data indicating maximum resources; and
controlling the first leaf processor to reduce load.

17. The vehicle of claim 15, wherein the at least one instruction is configured, when executed by the root processor, to cause the control circuit to select the first leaf processor by:
selecting, based on the resource management mode being identified according to the resource state data, another leaf processor, of the plurality of leaf processors, that has resource state data indicating maximum resources, and
wherein the resource management mode is identified based on the resource state data indicating that at least one state, of states of a plurality of components in the first leaf processor executing the application, indicates an unstable condition.

18. The vehicle of claim 14, wherein the at least one instruction is configured, when executed by the root processor, to cause the control circuit to identify the operating mode by:
detecting a redundancy mode by identifying, based on the failure state data, a failed leaf processor of the plurality of leaf processors,
wherein the at least one instruction is configured, when executed by the root processor, to cause the control circuit to select the first leaf processor by:
selecting a leaf processor, of the plurality of leaf processors and other than the failed leaf processor, based on the failure state data and the resource information of each of the plurality of leaf processors, and
wherein the at least one instruction is configured, when executed by the root processor, to cause the control circuit to select the first leaf processor further by:
selecting one or more leaf processor candidates, of the plurality of leaf processors, that have performance data indicating a predetermined similarity with the failed leaf processor in a normal state; and
selecting the first leaf processor, of the one or more leaf processor candidates, that has resource state data indicating maximum resources.

19. The vehicle of claim 18, wherein the at least one instruction is configured, when executed by the root processor, to further cause the control circuit to, prior to selecting the first leaf processor:
determine, based on the failure state data of the root processor, whether the root processor fails; and
replace, based on a failure of the root processor, the root processor by determining one of the plurality of leaf processors in the normal state as a replacement root processor, and
wherein the at least one instruction is configured, when executed by the replacement root processor, to cause the control circuit to select the first leaf processor and cause the first leaf processor to execute the application.

20. The vehicle of claim 14, wherein the at least one instruction is configured, when executed by the root processor, to cause the control circuit to identify the operating mode by:
detecting a thermal management mode by identifying, based on the thermal state data, a heat-generating leaf processor,
wherein the at least one instruction is configured, when executed by the root processor, to cause the control circuit to select the first leaf processor by:
selecting, based on the thermal state data and the resource information of each of the plurality of leaf processors, a leaf processor other than the heat-generating leaf processor, and
wherein the at least one instruction is configured, when executed by the root processor, to cause the control circuit to select the first leaf processor further by:
selecting one or more leaf processor candidates, from among one or more leaf processors having a reference thermal state or lower, having performance data having a predetermined similarity to the heat-generating leaf processor; and
selecting the first leaf processor, of the one or more leaf processor candidates, that has resource state data indicating maximum resources.
